(19) United States
(12) Patent Application Publication
(10) Pub. No.: US 2026/0338165 A1
(43) Pub. Date: Oct. 29, 2026

(54) METHODS FOR INSTALLING A CABLE-SUPPORTED ROTOR WIND TURBINE

(71) Applicant: VESTAS WIND SYSTEMS A/S, Aarhus N (DK)

(72) Inventors: Henrik SVENSTRUP, Risskov (DK); Jens TORBORG, Årre (DK); Jesper Hermann HANSEN, Varde (DK); Peter FYNBO, Risskov (DK)

(21) Appl. No.: 19/119,701

(22) PCT Filed: Oct. 10, 2023
(86) PCT No.: PCT/DK2023/050242

§ 371 Date: Apr. 9, 2025

(30) Foreign Application Priority Data
Oct. 10, 2022 (DK) PA202270491

(51) Int. Cl. F03D 13/10; B66C 23/18

(52) U.S. Cl. CPC F03D 13/139; B66C 23/185; F03D 13/104; F05B 2230/61

(57) ABSTRACT

A method of installing a cable system (30) including a cable assembly (32a-c) on a wind turbine (10) having a tower (12), a rotor (22), and a central hub (24). A plurality of blades (26a-c) is coupled to the hub (24). The cable assembly (32a-c) includes multiple cables (40a-c, 42a-c, 44a-c). A crane (102) has a hoist line (104, 106) and is attached to one of the cables (44a-c). The crane (102) lifts the cable assembly (32a-c) to the hub (24). The cable (44a-c) is then coupled to the hub (24). The hoist line (104, 106) is attached to another of the cables (40a-c, 42a-c), is moved to one of the blades (26a-c), and the cable (40a-c, 42a-c) is coupled to the one of the plurality of blades (26a-52c). Moving the cable (40a-c, 42a-c) may include pulling an end of the second cable (40a-c, 42a-c) to the one of the plurality of blades (26a-c). Pulling the end of the second cable (40a-c, 42a-c) may include moving the first crane (102) toward the one of the plurality of blades (26a-c).

### TECHNICAL FIELD

The invention relates generally to wind turbines, and more particularly to methods of installing a wind turbine on which a plurality of wind turbine blades is supported with cables.

### BACKGROUND

Wind turbines are used to produce electrical energy using a renewable resource and without combusting a fossil fuel. A wind turbine converts kinetic wind energy into mechanical energy and then subsequently converts the mechanical energy into electrical energy. A common type of wind turbine is the single rotor upwind horizontal-axis wind turbine (HAWT). An exemplary single-rotor HAWT includes a tower, a nacelle located at the apex of the tower, and a single rotor having a central hub and one or more blades (e.g., three blades) mounted to the hub and extending radially therefrom. The rotor is supported by the nacelle and positioned at the front of the nacelle so that the rotor faces into the wind upstream of its supporting tower. The rotor may be coupled either directly or indirectly with a generator (not shown) housed inside the nacelle and configured to convert the mechanical rotation of the rotor to electrical energy.

Wind turbine manufacturers continually strive to design and manufacture wind turbines with improved power production. The design of the wind turbine plays a significant role in the generated power output from wind. For example, energy obtained from the wind is proportional to the sweep area of the wind turbine blades. For single-rotor HAWTs, the sweep area may be increased by using longer wind turbine blades. The longer the blades, the larger the area that is traced by the blade tips. This translates to more energy extraction from the wind. However, the length, maximum chord length and root diameter of a wind turbine blade for a particular wind turbine is limited by several design factors.

As an exemplary limit, blade weight and root diameter increase with blade length. Each of these physical characteristics pose significant design challenges. For one, reliably supporting an increasingly heavier wind turbine blade at its attachment point at the rotor becomes a limiting factor. The increased loading at the root magnifies fatigue at this location during rotation of the rotor and during yaw motion of the rotor when the wind turbine is operational. Transportation of the blades from a manufacturing location to site installation is a known challenge and increasing blade length, root diameter, and weight make transportation more challenging.

One design solution that permits increased blade length is to support the wind turbine blades during wind turbine operation with cables. Cable supported blades may be relatively longer than a blade without cable support. Wind turbines utilizing rotors that are supported by cabling may be referred to as a “cable-supported rotor” or “cable-stayed rotor.” Specifically, a webbing of cables extends to and between adjacent blades. With the aid of cables, the blades are capable of being proportionally longer while addressing the design problems identified above. In this way, cable supported rotors may be utilized to increase the sweep area of the blades to produce more energy from the wind.

Accordingly, wind turbine manufacturers and operators seek improved wind turbines, and especially improved energy production while overcoming current design limitations including solutions to installation and attachment of cables at minimal cost while stabilizing wind turbine rotors during energy production.

### SUMMARY

To further these goals, and in a first aspect of the invention, a method of installing a wind turbine is disclosed. The wind turbine is preferably a single-rotor HAWT. In one embodiment, there is method of installing a cable system on the wind turbine. The cable system may include multiple cable assemblies but typically one cable assembly per blade. By way of example, a cable assembly includes a first cable, which may be a center wire, and a second cable, which may be a tip wire. The method includes providing a crane having at least one hoist line onto which the cable assembly is attached. The crane lifts the cable assembly to the hub with the hoist line. The first cable of the cable assembly is coupled to the hub. After disconnecting the hoist line from the cable assembly, the method includes attaching the hoist line to the second cable and moving the second cable to one of the plurality of blades with the hoist line.

The method further includes coupling the second cable to the one of the plurality of blades.

In one embodiment, the cable assembly includes a third cable, which may be a tip wire. The method further includes attaching a pulley to an adjacent one of the plurality of blades, operatively coupling a hoist cable to the pulley, attaching the hoist cable to the third cable, and pulling the hoist cable to draw the third cable toward the pulley. In one embodiment, the hoist cable is operatively coupled to a winch and pulling on the hoist cable includes drawing the hoist cable onto the winch. In one embodiment, pulling the hoist cable includes limiting a load on the hoist cable to below a predetermined level. For example, a load limiter is between the hoist cable and the third cable, and limiting the load includes limiting the load on the load limiter to less than 300 kg.

In one embodiment, the cable assembly includes a connector and one end of each of the first cable and the second cable, and optionally the third cable, is coupled to the connector and attaching the at least one hoist line to the cable assembly includes attaching the at least one hoist line to the connector. In one embodiment, attaching the hoist line to the cable assembly includes sewing a sling around the connector and attaching the hoist line to the sling.

In one embodiment, moving the second cable includes moving at least a portion of the first crane. As an example, the first crane includes a boom and a runner crane extending from an upper end of the boom. Moving at least a portion of the first crane includes changing an angle of the boom and/or the runner crane. As an additional/alternative example, moving the second cable includes translating the first crane from an initial position during coupling the first cable to the hub toward a second position, different from the first position.

In one embodiment, moving the second cable includes limiting a load on the at least one hoist line to below a predetermined level.

In one embodiment, providing the first crane includes providing a first hoist line and a second hoist line. In one embodiment, the first hoist line and the second hoist line are each separately, operatively coupled to the first crane. In one embodiment, during lifting of the cable assembly, the first hoist line and the second hoist line are horizontally spaced apart by 2 m to 5 m. In one embodiment, the first hoist line is operable from the first crane and the second hoist line is operable from a second device different from the first crane. Providing the second hoist line may include providing a second device different from the first crane. In one embodiment, providing the first crane includes providing a first hoist line, a second hoist line and a second device, which second hoist line is operable from the second device. As examples, the second device is one of a second crane, a cherry picker, and a fixed lift.

In one embodiment, providing the first crane includes providing the first hoist line coupled to a platform and attaching the at least one hoist line includes attaching the second hoist line to the cable assembly. In one embodiment, coupling the first cable to the hub is achieved from the platform. In one embodiment, coupling the second cable to the one of the plurality of blades is achieved from the platform.

Embodiments may include repeating lifting and moving other cables of the cable system until the cable system is installed on the rotor. The cable system is configured to support the wind turbine blades during operation. The support provided by the cable system enables longer blades to be utilized so that the energy production for the wind turbine may be increased relative to a wind turbine having relatively shorter blades.

A particularly advantageous type of cable-stayed rotors is cable-stayed pitchable rotors as pitching allows for simple and well-known control of the rotor speed. A particular type of cable-stayed pitchable rotors are rotors with blade connecting cables between neighbouring blades where the tension in the blade connecting cables is adjustable by tensioning a cable (also referred to as center cable) connected to the middle of the blade connecting cables and to a tensioning system of the hub. This allows for adjusting the tension in the cables during pitching operation. The methods of the present invention are therefore particularly advantageous for installation of a cable system for cable-stayed pitchable rotors.

Methods described herein may also be used for servicing, replacing, or removing a cable assembly instead of (or in connection with) installing a cable system. In these cases, the steps are typically performed in the opposite order, and for example instead of coupling a cable to the hub or blade, the cable is released from the hub or blade.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is an elevation view of a Cable Supported Rotor wind turbine according to embodiments of the invention;

FIG. 1A is an enlarged view of a cable system coupled to a rotor shown in FIG. 1;

FIG. 1B is an enlarged view of a connector shown in FIG. 1A;

FIG. 2 is a schematic elevation view of a wind turbine tower and a rotor and showing a system for installing the cable system of FIG. 1;

FIG. 3 is a schematic elevation view of the wind turbine tower and the rotor of FIG. 2 prior to installation of the cable system to the rotor according to one embodiment;

FIGS. 4, 4A, 5, 6, and 7 are schematic elevation views illustrating installation of the cable system of FIG. 1 to the rotor shown in FIG. 2;

FIGS. 7A and 7B are schematic views of a wire sock and the wire sock during its use with a wire tip, respectively, according to one embodiment;

FIG. 8 is a schematic elevation view illustrating one step for installation of the cable system of FIG. 1 to the rotor shown in FIG. 2;

FIG. 8a is an enlarge view of an exemplary connection location on a wind turbine blade in FIG. 8; and

FIG. 9 are schematic elevation views illustrating installation of the cable system of FIG. 1 to the rotor shown in FIG. 2.

### DETAILED DESCRIPTION

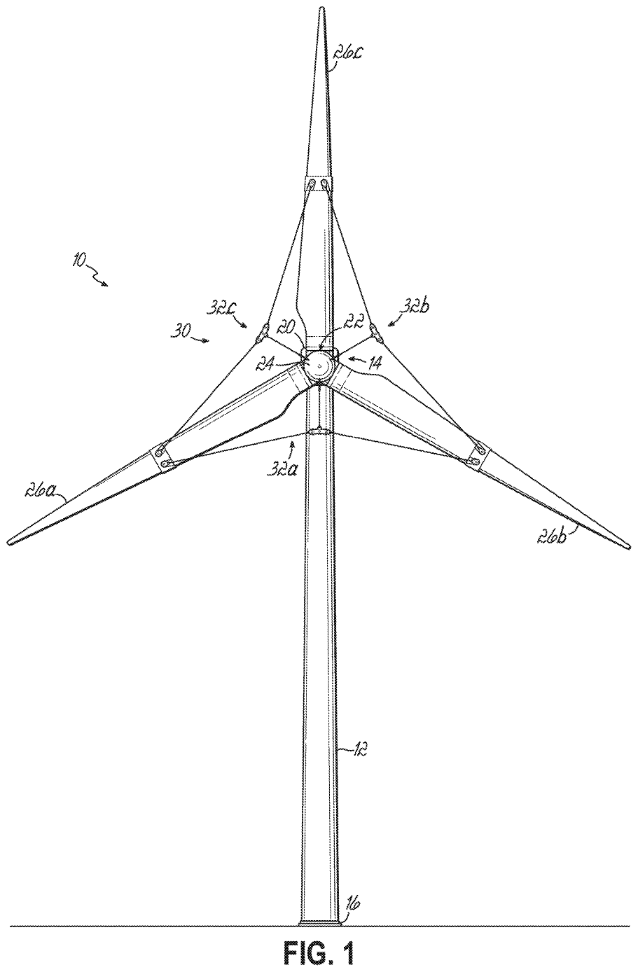

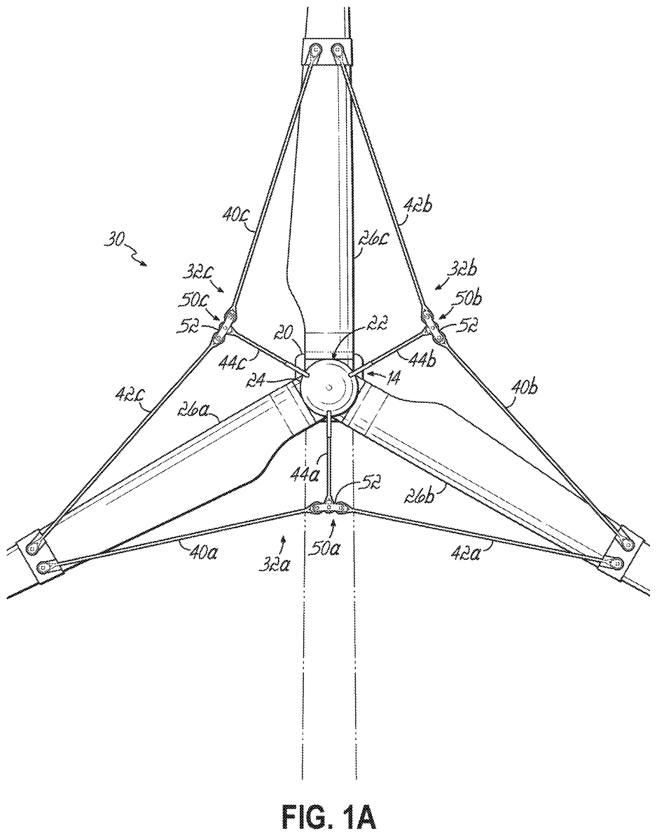

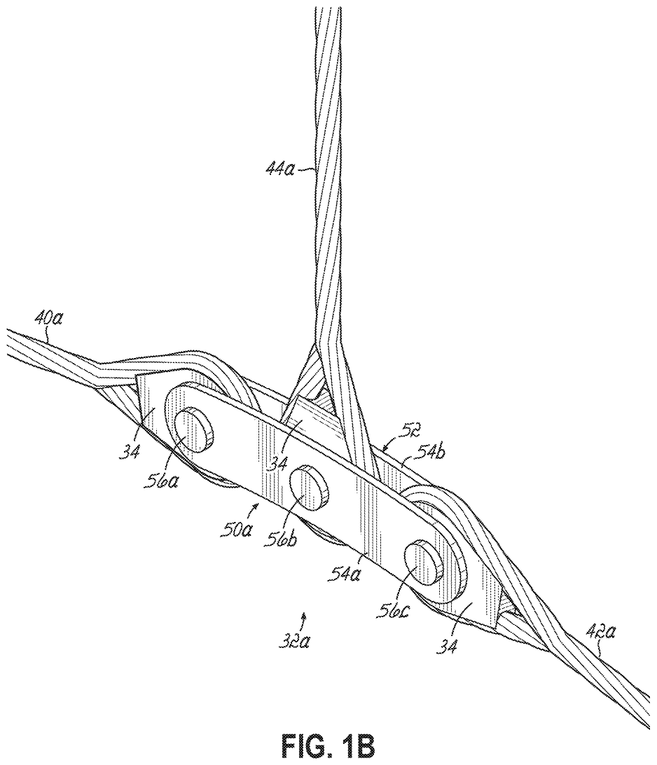

With reference to FIG. 1, a wind turbine 10 includes a tower 12 and an energy generating unit 14 (including a nacelle) disposed at the apex of the tower 12. The tower 12 may be coupled to a foundation 16 at a lower end thereof. The foundation 16 may be a relatively large mass (e.g., concrete, anchor cage, etc.) embedded in the ground and through which forces on the wind turbine 10 may be ultimately transferred. Although not shown, in an alternative embodiment, the foundation 16 may include an offshore platform or the like used in offshore wind turbine applications. The tower 12 supports the weight of the energy generating unit 14 and operates to elevate the energy generating unit 14 to a height above ground level or sea level at which faster moving air currents of lower turbulence are typically found.

In that regard, the energy generating unit 14 transforms the energy of the wind into electrical energy. The energy generating unit 14 typically includes a housing or nacelle 20, a rotor 22 having a central hub 24 and wind turbine blades 26a, 26b, 26c (e.g., three blades) mounted to the central hub 24 and extending radially therefrom. The energy generating unit 14 includes a drive train with a generator (not shown) for converting mechanical energy into electrical energy, optionally via a gear arrangement. A substantial portion of the drive train may be positioned inside of the nacelle 20 of the wind turbine 10. In addition to the generator, the nacelle 20 typically houses miscellaneous components required for converting wind energy into electrical energy and various components needed to operate, control, and optimize the performance of the wind turbine 10. The wind turbine blades 26a, 26b, 26c are configured to interact with the wind. The wind produces lift and causes the rotor 22 to spin or rotate to generally define a sweep area of the wind turbine blades 26a, 26b, 26c. The energy generating unit 14 generates power from the wind that passes through the swept area of the rotor 22. During operation of the wind turbine 10, wind turbine blades 26a, 26b, 26c are supported by a cable system 30, which carry some of the static and dynamic loads. In essence, the cable system 30 causes the wind turbine blades 26a, 26b, 26c to mutually support each other. For example, edgewise loads and flapwise loads are shared among the wind turbine blades 26a, 26b, 26c via the cable system 30.

As shown, in the exemplary embodiment of FIG. 1, the cable system 30 includes three cable assemblies 32a, 32b, 32c, one cable assembly 32a, 32b, 32c, for each wind turbine blade 26a, 26b, 26c. In an exemplary embodiment, each cable assembly 32a, 32b, 32c is connected to the rotor 22 at three locations, one connection at the central hub 24 and one connection at each of two adjacent wind turbine blades 26a, 26b, 26c. That is, individual ones of the cable assemblies 32a, 32b, 32c are coupled to and between adjacent wind turbine blades 26a, 26b, 26c and to the central hub 24. As shown, this forms a Y-shaped cable configuration between adjacent wind turbine blades 26a, 26b, 26c and central hub 24.

More specifically, and by way of example only, as is shown in FIG. 1A, the cable assembly 32a is coupled to the wind turbine blade 26a, to the wind turbine blade 26b, and to the central hub 24. Similarly, the cable assembly 32b is coupled to the wind turbine blade 26b, to the wind turbine blade 26c, and to the central hub 24, and the cable assembly 32c is coupled to the wind turbine blade 26c, the wind turbine blade 26a, and the central hub 24. By way of example, coupling the cable assembly 32a, 32b, 32c to the hub 24 may include connecting the cable assembly 32a, 32b, 32c to a cable tensioning system housed in the hub 24. An exemplary cable tensioning system may include one or more hydraulic cylinders to which the cable assembly 32a, 32b, 32c is connected. Stated another way, the cable assemblies 32a, 32b, 32c may be connected directly or indirectly to the wind turbine blades 26a, 26b, 26c and directly or indirectly to the central hub 24. Although not shown, connection between the cables of each assembly 32a, 32b, 32c and the rotor 22 may be by way of wire rope fittings commonly used in the industry. For example, and with reference to FIG. 1B, a solid thimble with integrated bearing 34 may define one or more cable ends in each assembly 32a, 32b, 32c. The fittings cooperate with other fittings or receptacles on the central hub 24 and/or on the wind turbine blades 26a, 26b, 26c to mechanically attach the assembly 32a, 32b, 32c sufficiently to carry a portion of the loads on the rotor 22. Further in that regard, while not shown in detail in the figures, each of the wind turbine blades 26a, 26b, and 26c may include a cable-to-blade connection point to which the cable assemblies 32a, 32b, or 32c are coupled. These connections are described in detail in commonly owned PCT Application Nos. PCT/DK2021/050374 and PCT/DK2022/050051, which are incorporated by reference herein in their entireties. Although not shown, by way of example only, the cable-to-blade connection may be at a split position between an inboard blade part and an outboard blade part, which are connected to each other to form the wind turbine blade. Such sectional blade designs are generally known in the wind turbine industry and may facilitate transportation of the blades. The connection point itself may be positioned outside of the wind turbine blade though at the split position. For example, a cable connection may extend outwardly from the blade and be available for connection to the cable system 30. Also not shown in the figures, the central hub 24 may include a cable-to-hub structure, such as a cable tensioning system described above, to which the cable assemblies 32a, 32b, 32c are coupled and by which the cable assemblies 32a, 32b, 32c are tensioned prior to and during operation of the wind turbine 10. A cable-to-hub structure usable for coupling to the cable assemblies 32a, 32b, 32c is also described in detail in commonly owned PCT Application Nos. PCT/DK2021/050374 and PCT/DK2022/050051. Embodiments of the invention are not limited to the number of wind turbine blades. Specifically, while the wind turbine 10 is shown with three wind turbine blades, embodiments of the invention may include more than three wind turbine blades with a cable assembly coupled between and to each of two adjacent blades and the central hub.

Advantageously, the cable system 30 according to embodiments of the invention carries a portion of the load on the wind turbine blades 26a, 26b, 26c, particularly during operation of the wind turbine 10. For instance, the cable system 30 carries at least a portion of the dynamic loads from movement of the wind turbine blades 26a, 26b, 26c due to the wind and gravity. The offloading of those loads from the blades 26a, 26b, 26c to the cable system 30 is advantageous. As one exemplary advantage, the blades 26a, 26b, 26c may be redesigned to be longer without substantially increasing their diameters at each blade root at its connection to the central hub 24 as compared to the diameter of wind turbine blades without cable support. Thus, a sweep area of the wind turbine blades 26a, 26b, 26c may be greater than a sweep area of wind turbine blades not supported by cables. Other advantages are also possible.

With continued reference to FIG. 1A, in one embodiment, one or more of the cable assemblies 32a, 32b, 32c includes two or more cables that are connected to one another and to the wind turbine blades 26a, 26b, 26c and to the central hub 24. In the exemplary embodiment shown, each cable assembly 32a, 32b, 32c includes three separate cables corresponding to each portion of the Y-shaped installed cable assembly. For example, cable assembly 32a includes a first cable 40a coupled to the wind turbine blade 26a at one end and a second cable 42a coupled to the wind turbine blade 26b at one end. The cable assembly 32a includes a third cable 44a coupled to the central hub 24. Each of the first and second cables 40a and 42a may be referred to herein as tip wires or tip cables, and the third cable 44a may be referred to as a center wire or center cable. Each of the tip wires 40a and 42a and center cable 44a is coupled at intersection 50a. One or more of the tip wires 40a, 42a and the center cable 44a may include a solid thimble with integrated bearing 34, described above, at one or both ends to connect to connection points on the wind turbine blade 26a, 26b and/or to the central hub 24, respectively. The two tip wires 40a and 42a may be manufactured as one unit with each end of the unit forming a tip wire. The two tip wires 40a and 42a and the center cable 44a may be manufactured as one unit, e.g. a T-shaped rope with three ends, with the ends of the unit forming two tip wires 40a, 42a and one center cable 44a, respectively.

Similarly, cable assembly 32b includes a first cable 40b coupled to the wind turbine blade 26b at one end, a second cable 42b coupled to the wind turbine blade 26c at one end, and a third cable 44b coupled to the central hub 24. Each of the first and second cables 40b and 42b may be referred to herein as tip wires or tip cables, and the third cable 44b may be referred to as a center wire or center cable. Each of the wires 40b, 42b, and 44b is coupled at intersection 50b. One or more of the tip wires 40b, 42b, and the center cable 44b may include a solid thimble with integrated bearing 34, described above, at one or both ends to connect to the wind turbine blade 26b, 26c, to the central hub 24, and/or at the intersection 50b.

And, cable assembly 32c includes a first cable 40c coupled to the wind turbine blade 26c at one end, a second cable 42c coupled to the wind turbine blade 26a at one end, and a third cable 44c coupled to the central hub 24. Each of the first and second cables 40c and 42c may be referred to herein as tip wires or tip cables, and the third cable 44c may be referred to as a center wire or center cable. Each of the wires 40c, 42c, and 44c is coupled at intersection 50c. One or more of the first cable 40c, the second cable 42c, and the third cable 44c may include a solid thimble with integrated bearing 34, described above, at one or both ends to connect to the wind turbine blade 26c, 26a, to the central hub 24, and/or at the intersection 50c.

With reference to FIG. 1B, by way of example, one or more of the intersections 50a, 50b, 50c may include a connector 52 to which first, second, and third cables of the respective cable assembly are coupled together. As shown in FIG. 1B, the connector 52 includes two opposing plates 54a, 54b joined together by three pins 56a, 56b, 56c. The pins 56a, 56b, 56c receiving a respective one end of the tip wire or end of the center wire, such as via the solid thimble with integrated bearing 34, to form a cable assembly. By way of example, one or more of the wires and cables of the cable system 30 may comprise a polymer material as load bearing component. The polymer material may, for example, be an Ultra High Molecular Weight Polyethylene (UHMWP). An exemplary UHMWP in the form of a fiber is manufactured under the tradename Dyneema®. Ultra High Molecular Weight Polyethylene fibres are particularly advantageous due to a combination of a high strength/weight ratio and good fatigue properties. As an alternative, the polymer material may be based on polyester, polyamid, nylon, polypropylene, aramid, etc. As another alternative, the polymer material may be a composite material, e.g. a liquid crystal polymer, such as polybenzoxazole (PBO). However, the cable system 30 is not limited to polymer material as various types of steel cabling may be utilized alone or in combination with polymer materials.

In FIGS. 1 and 1A, each cable assembly 32a, 32b, 32c is taut in its attachment between the central hub 24 and the wind turbine blades 26a, 26b, 26c. Tensioning the cable assemblies 32a, 32b, 32c may be achieved by a mechanism in the central hub 24. An exemplary mechanism is described in commonly owned PCT/DK2021/050374 and PCT/DK2022/050051 and may be achieved by the use of hydraulic cylinders or similar that are configured to pull on one or more of the center cables 44a, 44b, 44c following installation of the cable assemblies 32a, 32b, 32c, which is described below. Pulling on the center cable 44a, 44b, 44c in a direction toward the central hub 24 places the tip wires 40a, 40b, 40c, 42a, 42b, 42c and the center cables 44a, 44b, 44c in tension. Once tensioned, the cable assemblies 32a, 32b, 32c share loads imposed on the wind turbine blades 26a, 26b, 26c.

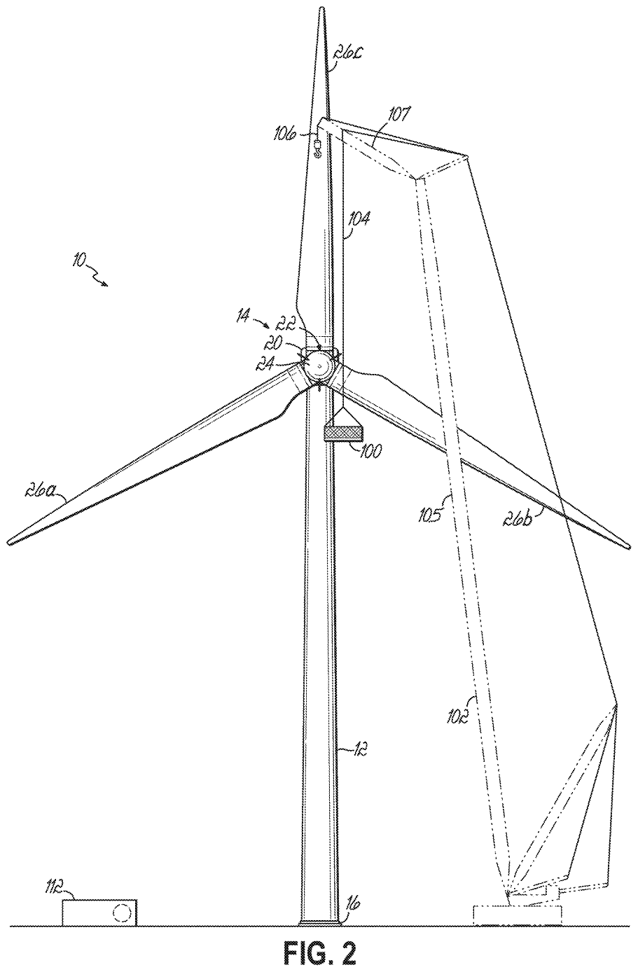

According to one embodiment of the invention, the cable system 30 is installed on the wind turbine 10 during or following installation of the rotor 22. An exemplary installation is shown with reference to FIGS. 2-9 in which the cable system 30 is installed after rotor installation is complete. In FIG. 2, the tower 12, energy generating unit 14 including the nacelle 20, and rotor 22 are assembled prior to installation of the cable system 30. Following assembly of the rotor 22, if necessary, the rotor 22 is rotated to the orientation shown in which an adjacent pair of blades 26a and 26b are in the 8 o'clock and 4 o'clock positions, respectively, but other orientations of the blades 26a-c may be used during installation of the cable system 30. A platform 100 is positioned proximate the central hub 24. In the exemplary installation, the platform 100 is a basket elevated by a crane 102 by a main hoist line 104 to enable personnel (e.g., construction workers) to manually access the central hub 24, the cable system 30, and the wind turbine blades 26a, 26b, 26c.

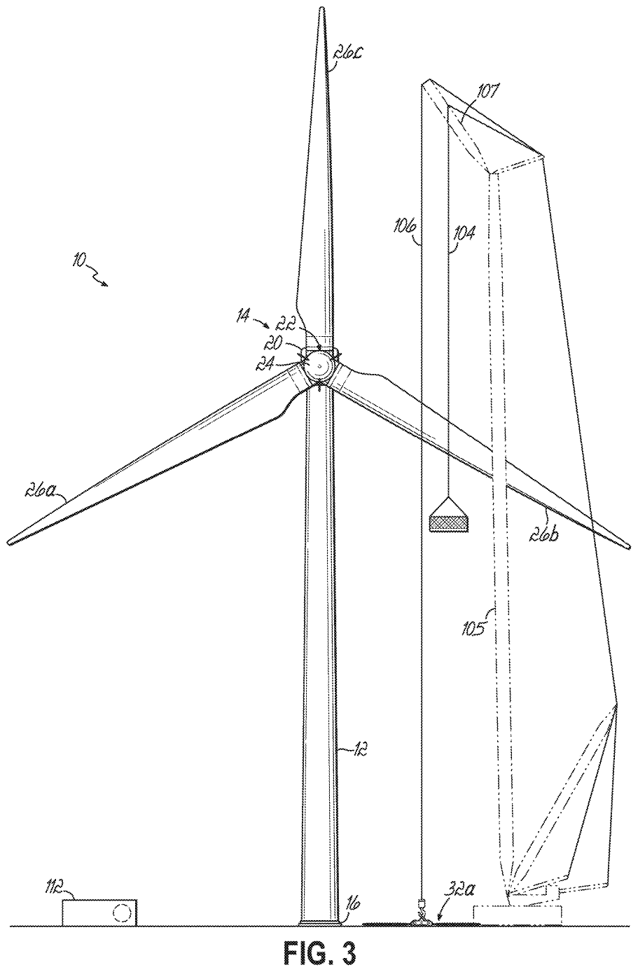

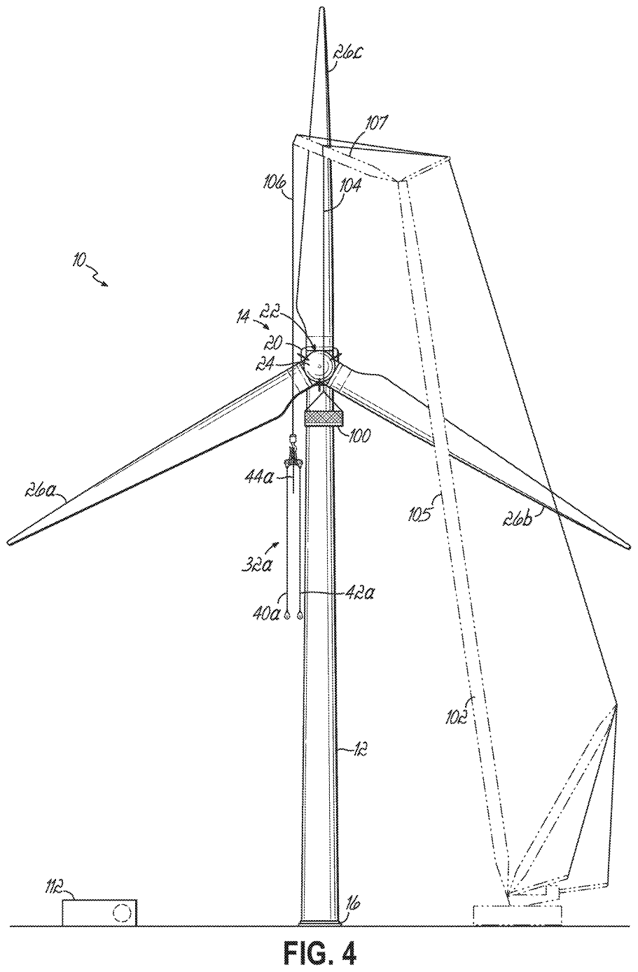

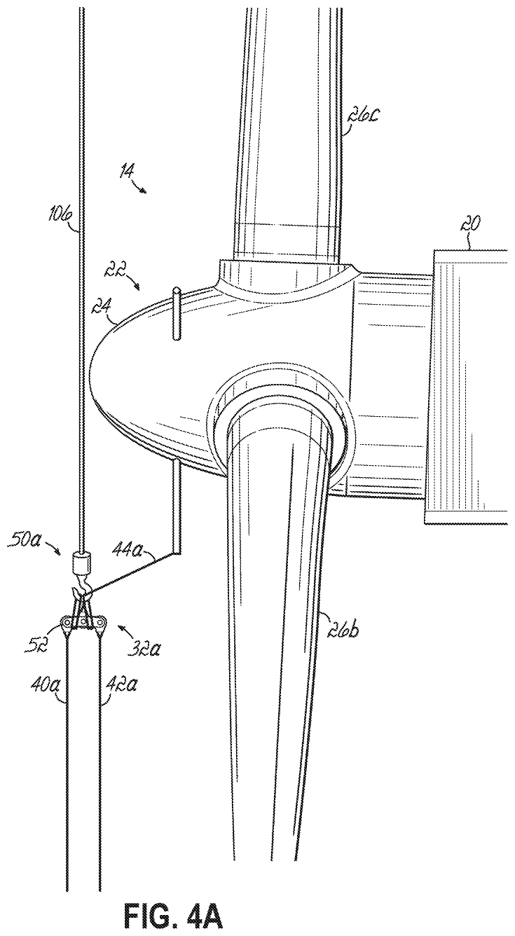

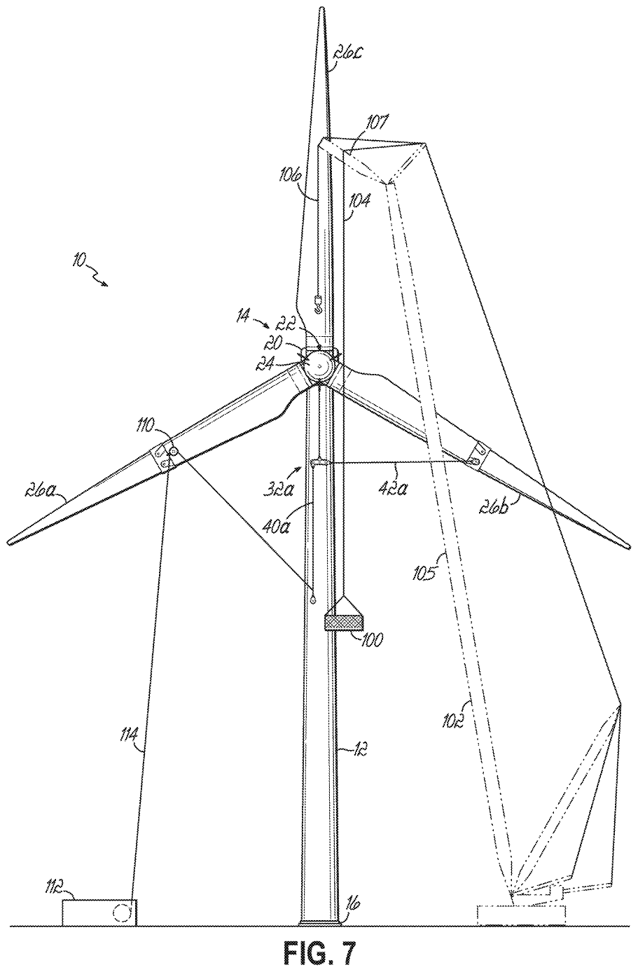

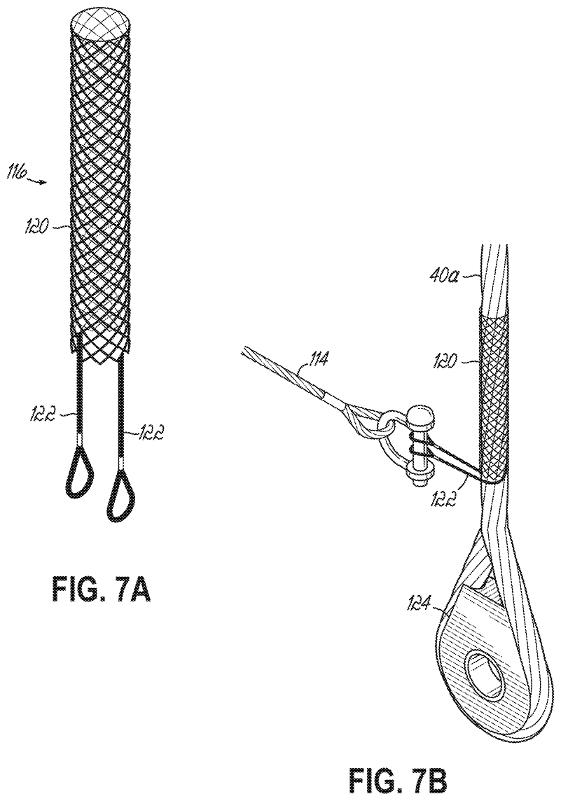

As shown in FIGS. 2 and 3, the crane 102 includes a boom 105 from which a runner crane 107 (also referred to as a jib) extends at an uppermost end of the boom 105. An auxiliary hoist line 106 is operable from an uppermost end of the runner crane 107 and may be equipped with a hook. The auxiliary hoist line 106 is separately operable from the main hoist line 104. The auxiliary hoist line 106 is proximate the platform 100. As an example, the auxiliary hoist line 106 may be spaced horizontally apart from the main hoist line 104 by 2 m to 5 m. The auxiliary hoist line 106 may be accessible from the platform 100, such as with a pole hook. With reference to FIG. 3, personnel attach the auxiliary hoist line 106 to a point of connection on the cable assembly 32a. By way of example, and although not shown, the auxiliary hoist line 106 may be attached to the center cable 44a via a wire sock, such as that shown in FIGS. 7A and 7B. Alternative connections between the auxiliary hoist line 106 and the cable assembly 32a may include attaching the hoist line 106 to the connector plate 52 via an eye bolt or swivel eye bolt secured to the plate 52 and attaching the hoist line 106 to a sling sewn around the connector plate 52 as is shown in FIG. 4. In the exemplary embodiment shown in FIG. 3, the cable assembly 32a, including the tip wires 40a and 42a and center cable 44a, each of which is coupled to the connector 52, is shown coiled up on the ground proximate the tower 12. The auxiliary hoist line 106 is attached to the cable assembly 32a via the sling and hook while the cable assembly 32a is on the ground as is shown in FIG. 3. By way of example only, the auxiliary hoist line 106 is indirectly attached to the connector 52 (FIG. 1B) of the cable assembly 32a. The center cable 44a therefore hangs from the connector 52 in FIG. 4.

With reference to FIGS. 4 and 4A, the auxiliary hoist line 106 is raised to lift the attached cable assembly 32a toward the hub 24. In that regard, platform 100 is not utilized to lift the cable assembly 32a. Although not shown, the auxiliary hoist line 106 may be a cable on another crane. That is, two separate cranes may be utilized rather than the single crane 102 shown. Further, other devices/systems separate from the crane 102 may be utilized to lift the cable assembly 32a toward the hub 24. For example, other combinations may include a crane and a cherry picker or a crane and a fixed lift. Once the cable assembly 32a is near the point of attachment of the cable assembly 32a to the central hub 24, personnel on the platform 100 couple the center cable 44a to the central hub 24 (e.g., a hydraulic cylinder). In this way, the auxiliary hoist line 106 and crane 102 carry the weight of the cable assembly 32a while personnel on the platform 100 couple the cable assembly 32a to the hub 24. The personnel may more easily manipulate and couple an end of the center cable 44a to the central hub 24. The auxiliary hoist line 106 is then disconnected from the cable assembly 32a, which is left to hang from the central hub 24 by the center cable 44a.

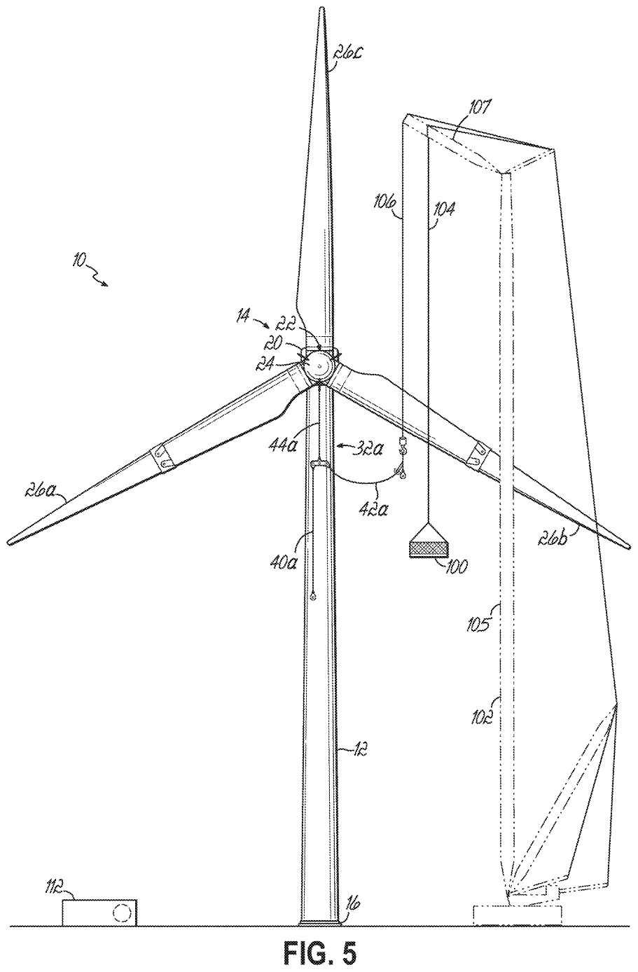

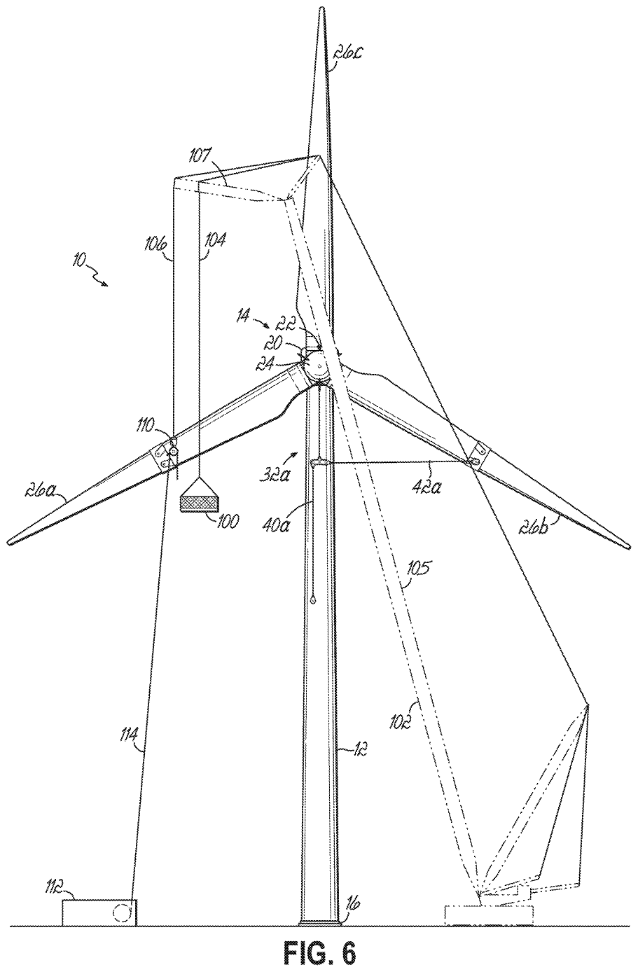

With reference to FIG. 5, personnel on the platform 100 attach the auxiliary hoist line 106 to the cable assembly 32a, specifically near the end of the tip wire 42a opposite the end coupled to connector 52. The crane 102 moves the platform 100 and the tip wire 42a via its attachment to the auxiliary hoist line 106 toward the wind turbine blade 26b. Moving the platform 100 and tip wire 42a may include moving the crane 102 by relocating the crane 102, yawing the boom 105, changing the angle of the boom 105 (as is shown by comparison of FIGS. 4 and 5), or a combination thereof. Although not shown, relocating the crane 102 may include translating the crane 102, with or without changing the orientation of one or both the boom 105 and runner crane 107, from one position along the ground and away from the tower 12 to a second position. In other words, the crane 102 in its entirety, rather than only the boom 105 and/or the runner crane 107, moves along the ground. Either way, movement of the crane 102 pulls the end of the tip wire 42a toward the wind turbine blade 26b. To avoid high lateral loads on the auxiliary hoist line 106, a load limiter (not shown) may be placed between the auxiliary hoist line 106 and the tip wire 42a. The load limiter may be in addition to a load cell that the crane 102 may be equipped with. With the platform 100 near the wind turbine blade 26b, personnel couple the tip wire 42a to the wind turbine blade 26b and then detach the auxiliary hoist line 106 from the tip wire 42a. The tip wire 42a is shown coupled to the wind turbine blade 26b in FIG. 6.

With reference to FIGS. 6 and 7, in one embodiment, a pulley 110 may be attached to the wind turbine blade 26a. To do so, the auxiliary hoist line 106 may be utilized to lift the pulley 110 into a position in which personnel on the platform 100 can attach the pulley 110 to the wind turbine blade 26a. A winch 112 is located on the ground proximate the wind turbine tower 12. A hoist cable 114 is withdrawn from the winch 112 and fed through the pulley 110, as shown. Personnel on the platform 100 then attach the hoist cable 114 to the tip wire 40a with a wire sock 116 such that an end of the tip wire 40a is more easily accessible for connection to the wind turbine blade 26a near the pulley 110. As shown in FIGS. 7A and 7B, the wire sock 116 may have a mesh-like blanket portion 120 that is configured to be wrapped around the tip wire 40a, and one or more eyelets 122 configured to be coupled to the hoist cable 114. With reference to FIG. 7B, the blanket portion 120 may be stitched together around the wire 40a. In one embodiment, the wire sock 116 is coupled near, but not at, the end of the tip wire 40a. This is shown, by way of example only, in FIGS. 7 and 7B.

With reference to FIGS. 7, 7A, and 7B, activating the winch 112 pulls the hoist cable 114 into the winch 112 and draws the tip wire 40a toward the wind turbine blade 26a. Advantageously, the winch 112 and the hoist cable 114 carry the weight of the tip wire 40a as it is pulled toward the wind turbine blade 26a. The auxiliary hoist line 106 may be moved to an out-of-the-way position as the winch 112 draws the tip wire 40a into position. Thus, in an exemplary embodiment, the auxiliary hoist line 106 is utilized only to draw the initial tip wire 42a to the wind turbine blade 26b. The tension in the hoist cable 114 may be monitored with a load cell during pulling. The load on the cable 114 may be measured and limited during pulling. For example, if the lateral load on the hoist cable 114 exceeds a predetermined level (e.g., in a range of 100 kg to 300 kg), the load limiter may stop further movement to limit or stop further increases in tension on the cable assembly 32a and/or the cable 114. The tension in the hoist cable 114 may be monitored during pulling. An integrated load cell or separate loadcell, for example, may be on or between the hoist cable 114 and the cable assembly 32a. With this arrangement, pulling can be stopped if the tension in the cable 114 or on the winch 112 exceeds a predetermined value to avoid damaging one of those components or the blade 26a. The pulley 110, winch 112, and cable 114 are utilized for attachment of the second tip wire 40a to the adjacent wind turbine blade 26a. By comparison, it is contemplated that utilizing the platform 100 to pull the tip wire 40a toward the wind turbine blade 26a would place significant horizontal loads on the platform 100 from the dead weight of the tip wire 40a and so tilt the platform 100. The use of the winch 112 and hoist cable 114 to pull the tip wire 40a significantly reduces or avoids placing horizontal loads on, and possibly tilting, the platform 100. Alternatively, and although not shown, the auxiliary hoist line 106 may be attached to the tip wire 40a in the same way as the tip wire 42a shown in FIG. 5. Movement of the crane 102 toward the wind turbine blade 26a moves the tip wire 40a into proximity of the wind turbine blade 26a. Personnel on the platform 100 may then couple the tip wire 40a to the wind turbine blade 26a. The lateral loads on the auxiliary hoist line 106 may be greater in this configuration than in the configuration shown in FIG. 5. As another alternative, each of the tip wires 40a and 42a and center wire 44a may be separate and lifted and coupled individually to the wind turbine blades 26a, 26b and hub 24, respectively. Once each is coupled to the rotor 22, the wires 40a, 42a, and 44a may be coupled together at connector 52.

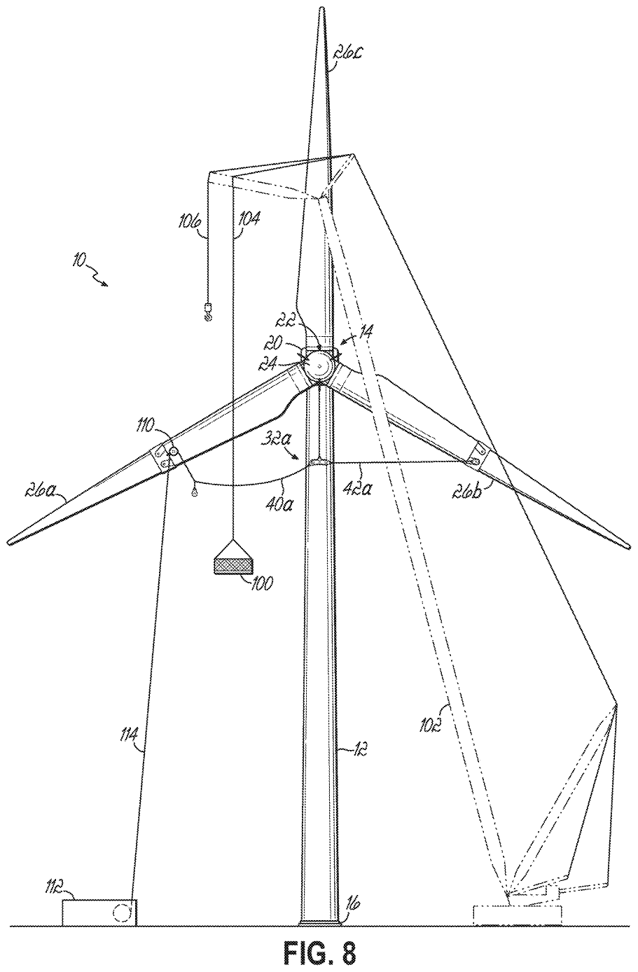

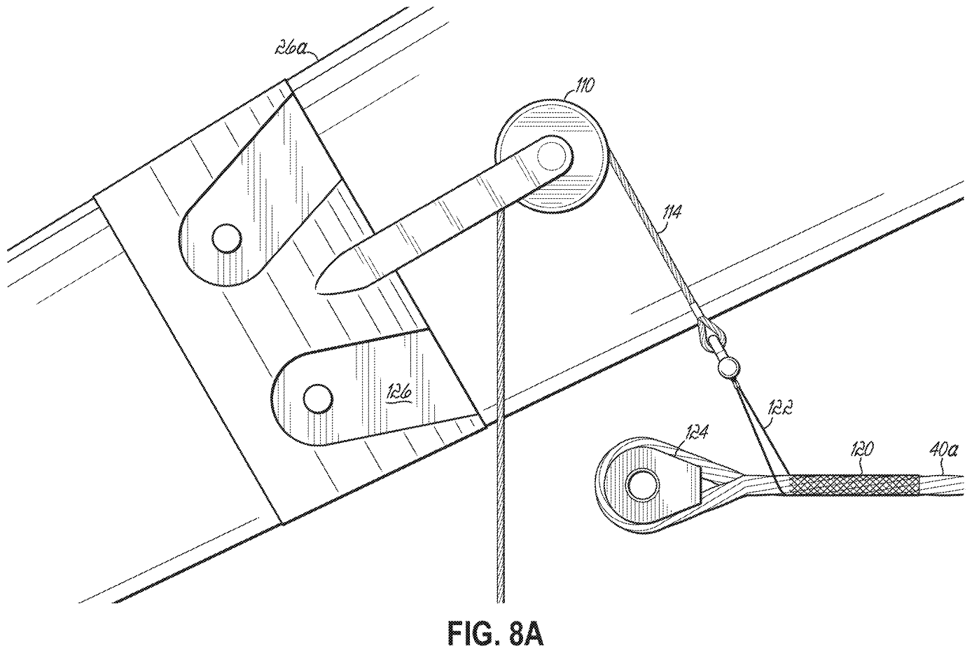

Referring to FIGS. 8 and 8A, with the end of the tip wire 40a near the wind turbine blade 26a and while the winch 112 holds the tip wire 40a in position, personnel on the platform 100 couple the tip wire 40a to the wind turbine blade 26a. Again, the winch 112 carries the bulk of the weight of the cable assembly 32a not supported by the hub 24 while personnel couple the end of the tip wire 40a to the wind turbine blade 26a. In the exemplary embodiment, a solid thimble with integrated bearing 124 defines the end of the tip wire 40a shown. In FIG. 8A, the bearing 124 is inserted into a receptacle 126 on the wind turbine blade 26a to couple the tip wire 40a (i.e., the cable assembly 32a) to the wind turbine blade 26a.

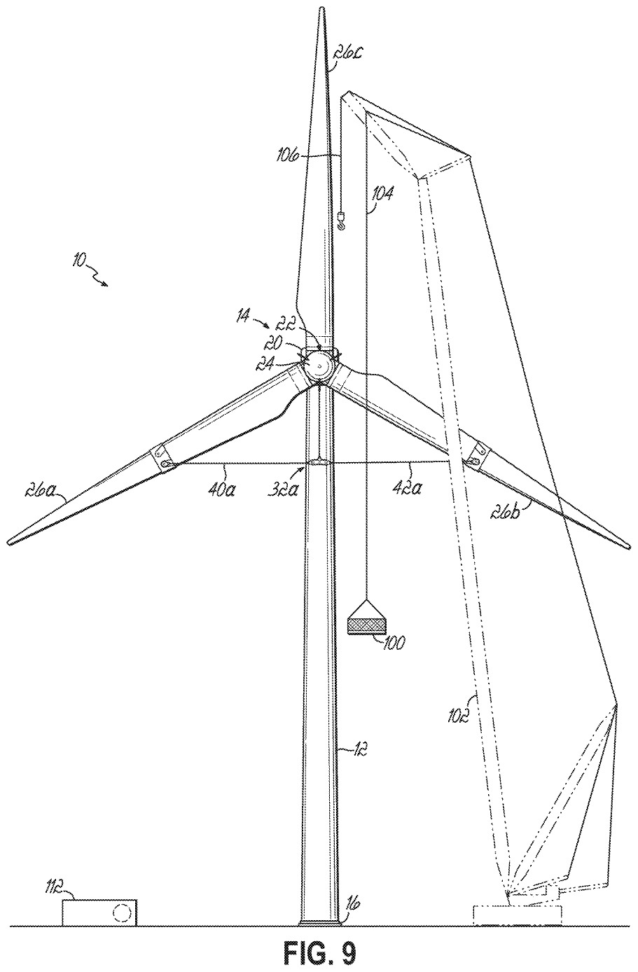

As shown in FIG. 9, the cable assembly 32a is secured between wind turbine blades 26a and 26b and to central hub 24. Although not shown in the figures, following coupling the cable assembly 32a to the rotor 22 as is shown schematically in FIGS. 2-9, the rotor 22 is rotated 120°to position either of the wind turbine blades 26b and 26c or wind turbine blades 26c and 26a in the 8 o'clock and 4 o'clock positions, respectively. Rotation of the rotor 22 by smaller or larger fraction of a full rotation may facilitate the installation process by changing the relative positions of the cables or blades, for example, so that gravity facilitates the installation or for safety reasons. One of the cable assemblies 32b and 32c is coupled to the respective adjacent wind turbine blades 26a, 26b, 26c in the same manner described above with reference to the cable assembly 32a to the wind turbine blades 26a and 26b in FIGS. 2-9. Following installation of one of the cable assemblies 32b and 32c according to that process, the rotor 22 is rotated 120° and the remaining cable assembly 32b or 32c is then coupled to the respective wind turbine blades 26a, 26b, 26c in the same manner. Thus, each cable assembly 32a, 32b, 32c is coupled to respective pairs of adjacent wind turbine blades 26a, 26b, 26c and to the central hub 24.

In detail, during installation of the cable assemblies 32b and 32c, which follows the procedure described above with respect to cable assembly 32a in FIGS. 2-9, the cable assembly 32b or 32c is coupled to the auxiliary hoist line 106 on the crane 102, the cable assembly 32b, 32c is hoisted with the auxiliary hoist line 106 toward the central hub 24, and the center cable 44b, 44c of the cable assembly 32b, 32c is coupled to the hub 24.

Once the cable assembly 32b, 32c is coupled to the hub 24, the auxiliary hoist line 106 is detached and is then coupled to one of the tip wires 42b, 42c, the tip wire 42b or 42c is drawn to the blade 26c or 26a by moving the crane 102, and the tip wire 42b, 42c is coupled to the blade 26c or 26a by personnel on the platform 100. The remaining tip wire 40b, 40c is coupled using the winch 112 and the hoist cable 114. That is, the pulley 110 is mounted to the wind turbine blade 26b, 26c and the winch 112 and the hoist cable 114, when attached to the tip wire 40b, 40c, draw that tip wire 40b, 40c to the wind turbine blade 26b, 26c so that the tip wire 40b, 40c can be coupled to the blade 26b, 26c.

As an example of the cable assembly 32b, once the center wire 44b is coupled to the hub 24, the tip wires 40b and 42b are then coupled to adjacent wind turbine blades 26b and 26c, respectively. In that regard, the auxiliary hoist line 106 is attached to the tip wire 40b or 42b and that tip wire 40b, 42b is pulled toward the wind turbine blade 26b or 26c. Once in position, the tip wire 40b or 42b is coupled to the blade 26b or 26c. For the remaining tip wire 40b or 42b, the auxiliary hoist line 106 may be utilized to raise a pulley 110 for attachment to the wind turbine blade 26b, 26c. Once the pulley 110 is attached and the hoist cable 114 is operably coupled to the winch 112 and to the tip wire 40b or 42b, the tip wire 40b or 42b is drawn to and coupled to the wind turbine blade 26b, 26c.

After rotating the rotor 22 by 120° to position the adjacent blades 26c and 26a in the 8 o'clock and 4 o'clock positions, the same process is repeated for the remaining adjacent pair of wind turbine blades 26c and 26a with remaining cable assembly 32c. Embodiments of the invention are not limited to any order with respect to which of the tip wires of the tip wire pairs 40a, 42a; 40b, 42b; and 40c, 42c is positioned with the auxiliary hoist line 106 and with the combination of the pulley 110, winch 112, and cable 114. However, in one exemplary embodiment, the auxiliary hoist line 106 is utilized initially to couple one of the tip wires of the pairs to the wind turbine blade 26a, 26b, 26c before the combination of the pulley 110, the winch 112, and the cable 114 are utilized to couple the other tip wire of the tip wire pair.

Following coupling, tension in each of the assemblies 32a, 32b, 32c is adjusted by operation of a tensioning system as is described in one or both of PCT Application Nos. PCT/DK2021/050374 and PCT/DK2022/050051.

Embodiments of the invention are exemplified with a single-rotor HAWT but are similarly useful for a multi-rotor HAWT on which the method may be used for installing a cable system for each of the rotors using the same steps and sequence as described above and thereby achieving the same advantages.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A method of installing a cable system including a cable assembly on a wind turbine including a tower and a rotor, the rotor having a central hub with a plurality of blades coupled to the central hub, the cable assembly including a first cable and a second cable, the method comprising:
providing a first crane having at least one hoist line operatively coupled thereto;
attaching the at least one hoist line to the cable assembly;
lifting the cable assembly to the hub with the at least one hoist line;
coupling the first cable to the hub;
after disconnecting the at least one hoist line from the cable assembly, attaching the at least one hoist line to the second cable;
moving the second cable to one of the plurality of blades with the at least one hoist line; and
coupling the second cable to the one of the plurality of blades.

2. The method of claim 1, wherein the cable assembly includes a third cable, the method further comprising:
attaching a pulley to an adjacent one of the plurality of blades;
operatively coupling a hoist cable to the pulley;
attaching the hoist cable to the third cable; and
pulling the hoist cable to draw the third cable toward the pulley.

3. The method of claim 2, wherein the hoist cable is operatively coupled to a winch and wherein pulling on the hoist cable includes drawing the hoist cable onto the winch.

4. The method of claim 2, wherein pulling the hoist cable includes limiting a load on the hoist cable to below a predetermined level.

5. The method of claim 4, wherein a load limiter is between the hoist cable and the third cable and wherein limiting the load includes limiting the load on the load limiter to less than 300 kg.

6. The method of claim 1, wherein the cable assembly includes a connector and one end of each of the first cable and the second cable is coupled to the connector and wherein attaching the at least one hoist line to the cable assembly includes attaching the at least one hoist line to the connector.

7. The method of claim 6, wherein attaching the at least one hoist line to the cable assembly includes sewing a sling around the connector and attaching the at least one hoist line to the sling.

8. The method of claim 1, wherein moving the second cable includes moving at least a portion of the first crane.

9. The method of claim 8, wherein the first crane includes a boom and a runner crane extending from an upper end of the boom and wherein moving at least a portion of the first crane includes changing an angle of the boom and/or the runner crane.

10. The method of claim 8, wherein moving the second cable includes translating the first crane from an initial position during coupling the first cable to the hub toward a second position, different from the first position.

11. The method of claim 1, wherein moving the second cable includes limiting a load on the at least one hoist line to below a predetermined level.

12. The method of any preceding claim 1, wherein providing the first crane includes providing a first hoist line and a second hoist line

13. The method of claim 12, wherein the first hoist line and the second hoist line are each separately, operatively coupled to the first crane.

14. The method of claim 12 wherein during lifting of the cable assembly, the first hoist line and the second hoist line are horizontally spaced apart by 2 m to 5 m.

15. The method of claim 12, wherein the first hoist line is operable from the first crane and the second hoist line is operable from a second device different from the first crane.

16. The method of claim 15, wherein the second device is one of a second crane, a cherry picker, and a fixed lift.

17. The method of claim 1, wherein providing the first crane includes providing the first hoist line coupled to a platform and wherein attaching the at least one hoist line includes attaching the second hoist line to the cable assembly.

18. The method of claim 17, wherein coupling the first cable to the hub is achieved from the platform.

19. The method of claim 17, wherein coupling the second cable to the one of the plurality of blades is achieved from the platform.
